(19) United States
(12) Patent Application Publication
(10) Pub. No.: US 2026/0093390 A1
(43) Pub. Date: Apr. 2, 2026

(54) CONTROL DEVICE AND CONTROL METHOD

(71) Applicant: CANON KABUSHIKI KAISHA, Tokyo (JP)

(72) Inventor: SHIMPEI KITAI, Chiba (JP)

(21) Appl. No.: 19/320,484

(22) Filed: Sep. 5, 2025

(30) Foreign Application Priority Data
Sep. 27, 2024 (JP) 2024-169095

(51) Int. Cl. G06F 3/04847; G06F 3/04817; G06F 3/04845

(52) U.S. Cl. CPC G06F 3/04847; G06F 3/04817; G06F 3/04845

(57) ABSTRACT

A control device includes: a processor; and a memory storing a program which, when executed by the processor, causes the control device to: execute display control processing of displaying an operation control for changing a setting value of an electronic device and changing a display size of the operation control by a predetermined operation; and execute change processing of changing an operation amount for the operation control for changing the setting value by a predetermined amount in accordance with the display size of the operation control.

### BACKGROUND

### Field of the Technology

The present disclosure relates to a control device and a control method.

### Description of the Related Art

In recent years, an imaging device such as a video camera has a wireless communication function and a wired connection function as standards. An application for controlling an imaging device connected to an information terminal such as a smartphone in a wireless or wired manner is disclosed, and a user can operate the imaging device by operating the application with the smartphone. Since the smartphone is operated by a touch panel, a plurality of operation controls having a tile shape or a wheel shape are arranged on a screen such that setting can be easily changed.

In recent years, a user who images a moving image to be posted on an SNS is increasing, and the user may operate the imaging device with the application of the smartphone and images the moving image alone. Depending on an imaging situation, there are some scenes where it is desired to greatly change setting values such as brightness and color, and some scenes where it is desired to perform fine adjustment of the setting values. In a case where the user performs imaging alone, the user holds the imaging device with one hand and operates the application of the smartphone with the other hand. In a case where the operation control is displayed at various places on the screen in the operation of the application, it may be difficult to perform the operation with a finger of one hand.

Japanese Patent Laid-Open No. 2008-262595 discloses a technique for accelerating scrolling in accordance with an input speed of the user. However, in a case where a scrolling operation is performed with one hand, since a movement range of the finger is limited, it is difficult to sufficiently accelerate the scrolling operation. In addition, Japanese Patent Laid-Open No. 2016-218764 discloses a technique for adjusting a reproduction position by a slide operation in a circular direction. However, since a speed at which the reproduction position moves by the slide operation does not change, the user adjusts a movement distance of the slide operation in accordance with a movement amount of the reproduction position in both a case where it is desired to greatly move the reproduction position and a case where it is desired to perform the fine adjustment. Thus, it may be difficult for the user to accurately adjust the reproduction position to a desired position.

### SUMMARY

The present disclosure provides a control device capable of greatly changing a setting value or performing fine adjustment of a setting value by a simple operation with one hand.

A control device according to the present disclosure includes: a processor; and a memory storing a program which, when executed by the processor, causes the control device to: execute display control processing of displaying an operation control for changing a setting value of an electronic device and changing a display size of the operation control by a predetermined operation; and execute change processing of changing an operation amount for the operation control for changing the setting value by a predetermined amount in accordance with the display size of the operation control.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a system.

FIG. 2 is a diagram illustrating a configuration example of a camera.

FIG. 3A is a diagram illustrating a configuration example of a mobile phone.

FIG. 3B is a diagram illustrating an appearance of the mobile phone.

FIGS. 4A and 4B are diagrams illustrating use examples of the mobile phone by a user during imaging.

FIG. 5 is a diagram illustrating a screen example of a camera control application.

FIGS. 6A to 6D are diagrams for explaining a change in a display size of an operation control.

FIGS. 7A to 7E are diagrams illustrating display modes of the operation control.

FIGS. 8A to 8D are diagrams for explaining an example in which a shape of the operation control changes.

FIGS. 9A and 9B are diagrams for explaining a series of operations for the operation control.

FIG. 10A is a flowchart illustrating setting change processing corresponding to a user operation.

FIG. 10B is a flowchart illustrating setting change processing corresponding to a user operation.

FIG. 10C is a flowchart illustrating setting change processing corresponding to a user operation.

### DESCRIPTION OF THE EMBODIMENTS

Hereinafter, embodiments of the present disclosure will be described with reference to the drawings.

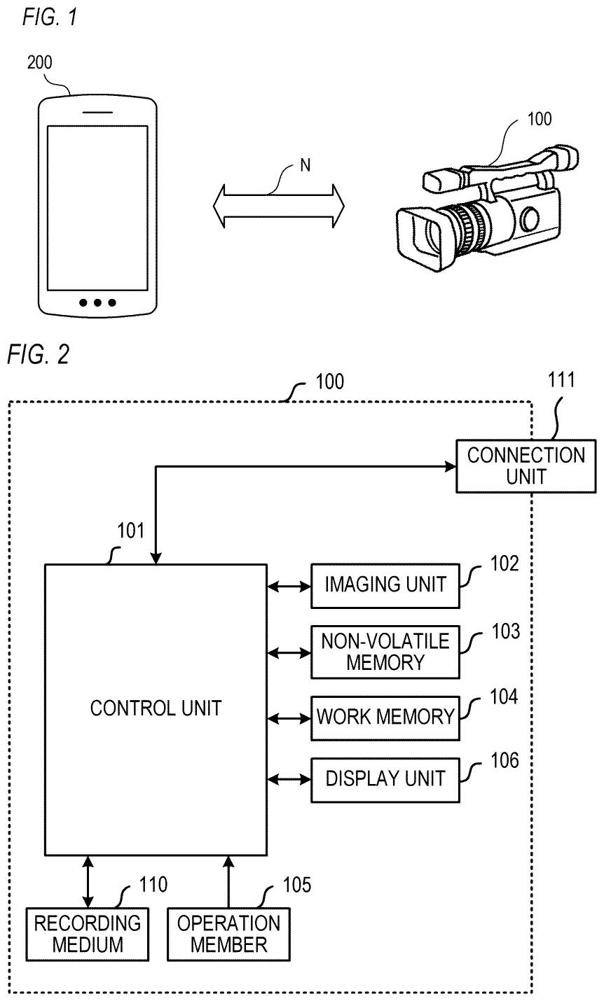

(System Configuration) FIG. 1 is a diagram illustrating a configuration of a system. The system according to the present embodiment includes a camera 100 as an example of an electronic device and a mobile phone 200 as an example of a control device. The camera 100 and the mobile phone 200 are connected by a network N.

The network N is, for example, Wi-Fi (trademark), but is not limited thereto. The network N may be Bluetooth (trademark) and other wireless communication schemes. In addition, the network N may be wired communication. RS-232C, RS-422A, USB, Ethernet (trademark), or the like is used as a wired communication scheme. The network N may employ any communication scheme as long as images and setting values of the camera 100 can be transmitted and received.

(Configuration of Camera) FIG. 2 is a diagram illustrating a configuration example of the camera 100. The camera 100 may be an electronic device that can communicate with the mobile phone 200 as the control device and can be operated by the mobile phone 200. The electronic device is not limited to an imaging device such as a video camera or a digital still camera, and may be a tablet terminal, a personal computer, or the like. The camera 100 includes a control unit 101, an imaging unit 102, a non-volatile memory 103, a work memory 104, an operation member 105, a display unit 106, a recording medium 110, and a connection unit 111.

The control unit 101 controls the units of the camera 100 according to input signals and various programs for realizing functions of the camera 100. Note that, instead of the control unit 101 controlling the entire camera 100, processing may be shared by a plurality of pieces of hardware to control the camera 100 in whole or part.

The imaging unit 102 converts an object image (optical image) formed by a lens included in the imaging unit 102 into an electrical signal. The imaging unit 102 performs noise reduction processing or the like on the electrical signal, converts the electrical signal into digital data, and outputs the digital data as image data. The output image data is stored in a buffer memory. The control unit 101 performs predetermined arithmetic processing on the image data of the buffer memory and records the image data in the recording medium 110.

The non-volatile memory 103 is a non-volatile memory that is electrically erasable and recordable, and stores a program to be executed by the control unit 101 or the like. The work memory 104 is used as the buffer memory that temporarily retains the image data imaged by the imaging unit 102, an image display memory of the display unit 106, a work region of the control unit 101, or the like.

The operation member 105 is used for receiving an instruction for the camera 100 from a user. The operation member 105 includes, for example, operation members such as a power button for the user to switch between turned-on and turned-off of the power of the camera 100, a release button for receiving an imaging operation from the user, and a reproduction button for instructing reproduction of the image data. In addition, the operation member 105 also includes a touch panel formed in the display unit 106.

Note that, the release button includes a first shutter switch SW1 and a second shutter switch SW2. The first shutter switch SW1 is turned on in the middle of the operation of the release button, that is, by so-called half-pressing (imaging preparation instruction). The first shutter switch SW1 is turned on, and thus, imaging preparation processing such as autofocus (AF) processing, auto exposure (AE) processing, auto white balance (AWB) processing, or pre-flash (EF) processing is started. The second shutter switch SW2 is turned on by a completion operation of the release button, that is, so-called full-pressing (imaging instruction). The second shutter switch SW2 is turned on, and thus, a series of imaging processing from when an image file including an imaged image is generated to when the image file is written in the recording medium 110 is started.

The display unit 106 displays a live view image at the time of imaging, an imaged image, character information for interactive operation, and the like. Note that the display unit 106 may not be built in the camera 100. The camera 100 may be connected to an external display unit 106 and may have a display control function of controlling display on the connected display unit 106.

The recording medium 110 can record the image data output from the imaging unit 102. The recording medium 110 may be attachable and detachable to and from the camera 100 or may be built in the camera 100. The camera 100 may have a function of recording data in the recording medium 110 or reading data from the recording medium 110.

The connection unit 111 is an interface for connection to an external device. The camera 100 can exchange data with the external device via the connection unit 111. The connection unit 111 includes, for example, an interface for communication with the external device via a wireless LAN. The control unit 101 realizes wireless communication with the external device by controlling the connection unit 111. Note that the communication scheme is not limited to the wireless LAN such as Wi-Fi (trademark).

Note that, the camera 100 can operate as a slave device in an infrastructure mode of wireless LAN communication. In a case where the camera 100 operates as the slave device, the camera 100 can be connected to a peripheral access point (hereinafter, AP) to participate in a network formed by the AP. The camera 100 is one type of the AP and can also operate as a simplified AP (hereinafter, simple AP) having a more limited function. The AP is an example of a relay device. In a case where the camera 100 operates as the simple AP, the camera 100 itself forms a network. A peripheral device of the camera 100 can recognize the camera 100 as the AP and can participate in the network formed by the camera 100. A program for the camera 100 to operate as the AP or the simple AP is retained in the non-volatile memory 103.

The camera 100 is one type of the AP, and does not have a gateway function of transferring data received from the slave device to an Internet service provider or the like. Accordingly, even though the camera 100 receives data from another device participating in the network formed by the camera 100 itself, the camera 100 does not transfer the received data to the network such as the Internet.

The connection unit 111 is not limited to an interface for wireless communication, and may be an interface for wired communication. The connection unit 111 may be an interface corresponding to a communication scheme of wired communication by RS-232C, RS-422A, USB, Ethernet (trademark), or the like.

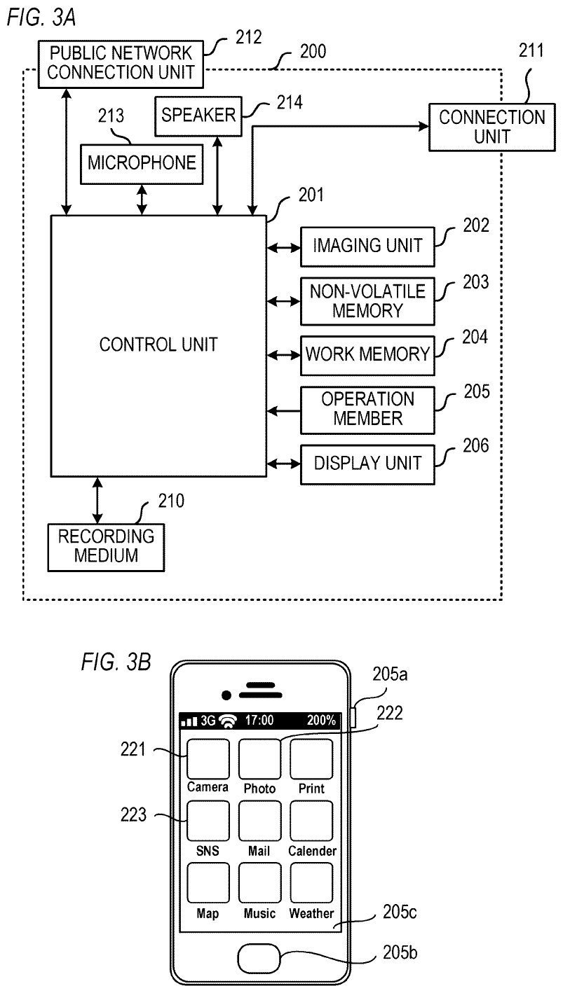

(Configuration of Control Device) The mobile phone 200 will be described with reference to FIGS. 3A and 3B. FIG. 3A is a diagram illustrating a configuration example of the mobile phone 200. Note that, the mobile phone 200 is an example of the control device, and the control device is not limited to the mobile phone 200. The control device may be any device that can communicate with the camera 100 in a wired or wireless manner and can execute an application for operating the camera 100. Examples of the control device include a digital camera, a media player, a tablet device, a personal computer, and a smartphone.

A control unit 201 controls the units of the mobile phone 200 according to input signals and various programs for realizing functions of the mobile phone 200. Note that, instead of the control unit 201 controlling the entire mobile phone 200, processing may be shared by a plurality of pieces of hardware to control the mobile phone 200 in whole or part.

An imaging unit 202 converts an object image (optical image) formed by a lens included in the imaging unit 202 into an electrical signal. The imaging unit 202 performs noise reduction processing or the like on the electrical signal, converts the electrical signal into digital data, and outputs the digital data as image data. The output image data is stored in a buffer memory. The control unit 201 performs predetermined arithmetic processing on the image data of the buffer memory and records the image data in a recording medium 210.

A non-volatile memory 203 is a non-volatile memory that is electrically erasable and recordable, and stores an operating system (OS) that is basic software to be executed by the control unit 201, various programs, and the like.

The non-volatile memory 203 further retains a program for communicating with the camera 100. A program for communicating with the camera 100 is installed as a camera control application on the mobile phone 200. Processing of the mobile phone 200 is realized by the control unit 201 reading and executing a program provided by the camera control application. The camera control application has a function for using basic functions (for example, a function of a wireless LAN, a function of Bluetooth (trademark), and a function of calling another application) of the OS installed on the mobile phone 200. The camera control application has a function of displaying a live view image received from the camera 100 on a display unit 206 and remotely operating the camera 100 on the basis of an instruction of the user. The camera control application has a function of executing imaging by the camera 100, browsing of the image data recorded in the recording medium 110 of the camera 100, reception of the image data, and the like by remote control from the mobile phone 200.

Note that, the camera control application may not be installed on the mobile phone 200, and a program for realizing the function of the camera control application may be included in the OS of the mobile phone 200.

A work memory 204 is used as the buffer memory that temporarily stores the image data imaged by the imaging unit 202, an image display memory of the display unit 206, a work region of the control unit 201, or the like.

An operation member 205 is used for receiving an instruction for the mobile phone 200 from the user. The operation member 205 includes, for example, an operation member such as a power button for the user to switch between turned-on and turned-off of the power of the mobile phone 200 and a touch panel formed on the display unit 206.

The display unit 206 displays image data, character information for interactive operation, and the like. Note that, the display unit 206 may not be built in the mobile phone 200. The mobile phone 200 may be connected to an external display unit 206 and may have a display control function of controlling the display of the connected display unit 206.

The recording medium 210 can record the image data output from the imaging unit 202, the image data received from the camera 100, or the like. The recording medium 210 may be attachable and detachable to and from the mobile phone 200 or may be built in the mobile phone 200. The mobile phone 200 may have a function of recording data in the recording medium 210 or reading data from the recording medium 210.

A connection unit 211 is an interface for connection to an external device. The mobile phone 200 can exchange data with the external device via the connection unit 211. The connection unit 211 includes an interface for communication with the external device via a wireless LAN. The control unit 201 realizes wireless communication with the external device by controlling the connection unit 211.

Note that, the mobile phone 200 can operate as a slave device in an infrastructure mode of wireless LAN communication and can participate in a network formed by a peripheral AP. In addition, the camera 100 may operate as a simple AP, and the mobile phone 200 may participate in the simple AP of the camera 100.

A public network connection unit 212 is an interface used to perform public wireless communication. The mobile phone 200 can make a call and perform data communication with another device via the public network connection unit 212. During a call, the control unit 201 performs input and output of audio signals via a microphone 213 and a speaker 214. The public network connection unit 212 includes, for example, an interface for performing communication using 3G. Note that, the public network connection unit 212 is not limited to 3G, and may use other communication schemes such as LTE, WiMAX, ADSL, FTTH, 4G, and 5G. In addition, the connection unit 211 and the public network connection unit 212 may be used as one antenna instead of being constituted by independent hardware.

An appearance of the mobile phone 200 will be described with reference to FIG. 3B. FIG. 3B is a diagram illustrating the appearance of the mobile phone 200. A power button 205a, a home button 205b, and a touch panel 205c are examples of the operation member 205. When the user presses the home button 205b, the control unit 201 interrupts an application being executed and displays a home screen for selecting another application on the display unit 206.

On the home screen of the mobile phone 200, items corresponding to applications are arranged. An item is pressed (touched), and thus, the user can activate an application or call an application being activated in a background. For example, an item 221 is an item for activating a camera control application for the mobile phone 200 to communicate with the camera 100. An item 222 is an item for activating an image display application for the user to view an image stored in the mobile phone 200. An item 223 is an item for activating a social network service (SNS) application that communicates with a server and shares images, sentences, and the like with other users.

The camera control application is an application provided by a manufacturer who manufactured the camera 100. The image display application is, for example, an application mounted as standard on the OS of the mobile phone 200, and is pre-installed on the mobile phone 200. The SNS application is an application provided by a developer who provides the SNS.

When the item 221 is pressed (touched) on the home screen, in a case where the camera control application is not yet activated, the control unit 201 newly activates the camera control application and displays an initial screen. In a case where the camera control application is being executed in the background, the control unit 201 displays a screen of the camera control application being executed again in a foreground.

In the mobile phone 200, the user inputs a predetermined instruction to the OS, and thus, the user can switch or execute an application without using the home screen. The application being executed when the predetermined instruction is input is not displayed on the display unit 206, and the execution is continued in the background. The application instructed as a switching destination by the user is newly activated or switched from the execution in the background to the execution in the foreground.

In the following description, in a case where the mobile phone 200 is described as a subject of processing, the control unit 201 actually realizes various types of processing by reading and executing a program stored in the non-volatile memory 203. In addition, in a case where the camera 100 is described as the subject of processing, the control unit 101 actually realizes various types of processing by reading and executing a program stored in the non-volatile memory 103.

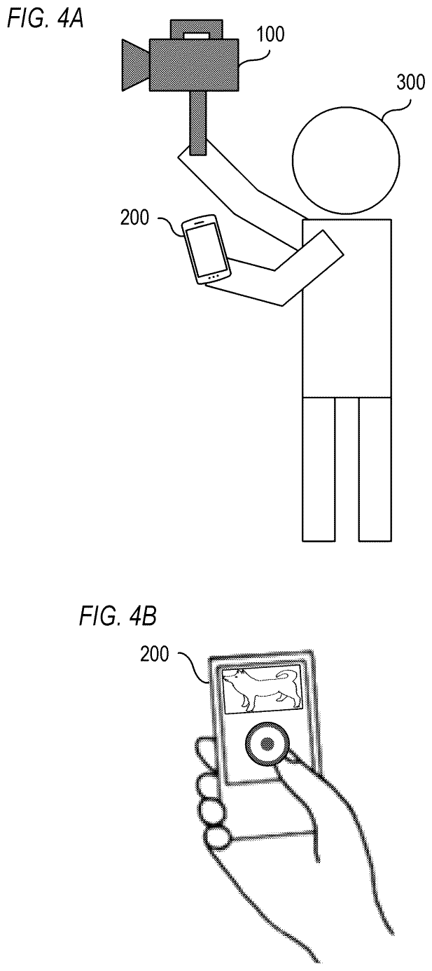

(Description of Use Examples of Mobile Phone) FIGS. 4A and 4B illustrate use examples of the mobile phone 200 by the user during imaging. FIG. 4A illustrates a scene in which a user 300 uses the mobile phone 200 while imaging with the camera 100. The camera 100 and the mobile phone 200 are connected via the network N as illustrated in FIG. 1. FIG. 4B illustrates a scene in which the user 300 operates the camera control application in the mobile phone 200. Since the user 300 holds the camera 100 with one hand, the mobile phone 200 is operated with one hand. In this case, the user 300 operates the camera control application with one thumb.

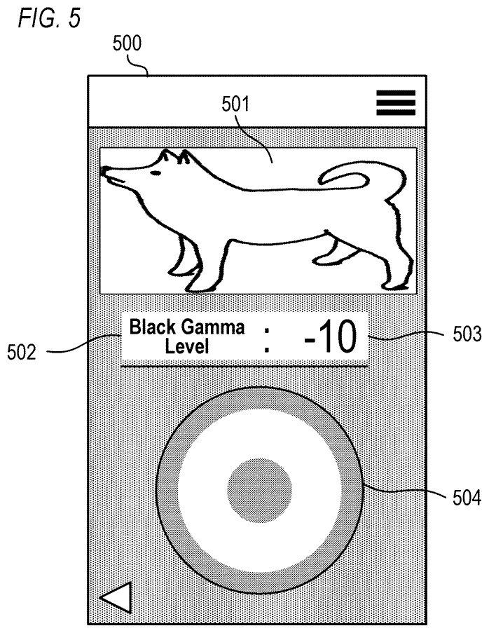

(Description of Screen of Camera Control Application) FIG. 5 illustrates a screen example of the camera control application displayed on the display unit 206 of the mobile phone 200. Through communication with the camera 100, the camera control application can receive an image imaged by the camera 100 and information of various current settings of the camera 100 and can display the image and information on a screen of the camera control application.

FIG. 5 illustrates an operation screen 500 which is an example of the screen of the camera control application. The camera control application is connected to the camera 100, receives an image imaged by the camera 100 and information of various current settings of the camera 100, and displays the image and information on the screen of the display unit 206.

An image region 501 is a region for displaying an image received from the camera 100. A setting item 502 displays a setting item whose setting value is to be changed. A setting value 503 displays a current setting value of the setting item 502. The camera control application can transmit a setting value changed by an operation of the user to the camera 100. The camera 100 changes the setting value of the setting item to be changed to the received changed setting value. An operation control 504 is an operation item for changing the setting value displayed in the setting value 503, and is displayed on the operation screen 500. In the example of FIG. 5, the operation control 504 is indicated by a circular wheel, but may have another shape such as a triangle or a square. Note that, in the following description, in a case where the operation control 504 is not particularly distinguished from operation controls in other display modes, the operation control 504 is used as a word including operation controls in various display modes in which a display size, shape, color, and the like are changed.

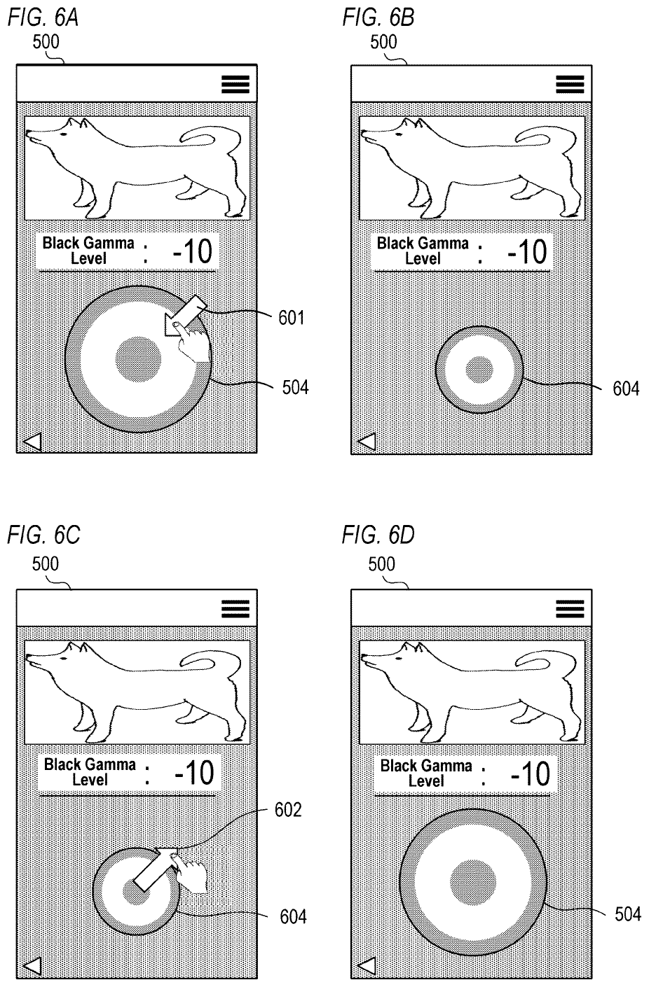

FIGS. 6A to 6D are diagrams for explaining a change in the display size of the operation control 504. The user can change the display size of the operation control 504 displayed on the operation screen 500 by a predetermined operation. The predetermined operation is an operation for changing the display size of the operation control 504, and is, for example, a drag operation between a central portion of the operation control 504 and an outer side of an outer periphery. The operation control 504 and an operation control 604 displayed in FIGS. 6A to 6D are arranged such that center coordinates are common.

FIG. 6A is a diagram illustrating that a drag operation 601 is performed on the operation control 504. FIG. 6B is a diagram illustrating the operation screen 500 on which the operation control 604 reduced by the drag operation 601 is displayed. The drag operation 601 is a drag operation from the outer side of the outer periphery of the operation control 504 toward the central portion. In a case where a touch position (coordinates of the touch position) enters the outer periphery of the operation control 604 obtained by reducing the operation control 504 by the drag operation 601, the display size of the operation control 504 is reduced to the display size of the operation control 604 in FIG. 6B.

When an operation of changing the setting value (hereinafter, also described as a setting change operation) is performed on the operation control 504 or 604, operation amounts for the operation controls 504 and 604 for changing the setting values by predetermined amounts are different. The setting change operation is, for example, an operation of moving the touch position along the outer periphery of the operation control 504 or 604. The outer periphery mentioned here may include regions inside and outside the operation control 504 or 604.

Note that, the mobile phone 200 is not limited to a case where a change amount for the operation control 504 for changing the setting value by the predetermined amount is changed in accordance with the display size of the operation control 504, and may change the change amount of the setting value corresponding to the operation of the predetermined operation amount for the operation control 504. The change amount of the setting value corresponding to the operation of the predetermined operation amount for the operation control 504 is changed in accordance with the display size of the operation control 504, and thus, the user can easily switch between coarse adjustment and fine adjustment by the operation with one hand.

As the display size of the operation control 504 becomes larger, the operation amount for the operation control 504 for changing the setting value by the predetermined amount becomes larger. Accordingly, in FIGS. 6A and 6B, the operation amount for the operation control 504 for changing the setting value by the predetermined amount is larger than the operation amount for the operation control 604. In this case, since the user can change the setting value by the predetermined amount with an operation amount smaller than the operation control 504 by the setting change operation for the operation control 604, the setting value can be roughly adjusted (coarse adjustment). In addition, since the user can change the setting value by the predetermined amount with an operation amount larger than the operation control 604 by the setting change operation for the operation control 504, the setting value can be finely adjusted.

A magnitude of the operation amount for changing the setting value by the predetermined amount is set in advance in accordance with the display size of the operation control 504 or 604. That is, the operation amount for the operation control 504 or 604 for changing the setting value by the predetermined amount is changed in accordance with the display size of the operation control 504 or 604. FIGS. 6A and 6B illustrate the operation control 504 and the operation control 604 having two display sizes, but the display size of the operation control is not limited to two, and may be three or more.

FIG. 6C is a diagram illustrating that a drag operation 602 is performed on the operation control 604. FIG. 6D is a diagram illustrating the operation screen 500 on which the operation control 504 enlarged by the drag operation 602 is displayed. The drag operation 602 is a drag operation from the central portion of the operation control 604 toward the outer side of the outer periphery. In a case where the touch position (the coordinates of the touch position) is moved to the outer side of the outer periphery of the operation control 604 by the drag operation 602, the display size of the operation control 604 is enlarged to the display size of the operation control 504 in FIG. 6D.

The user can perform the setting change operation while continuing touching without releasing the finger in the middle of the drag operation 601 and the drag operation 602. The user can change the setting value of the setting item to be changed by an operation in a direction different from the drag operation 601 or the drag operation 602 (a direction along the outer periphery of the operation control 504 or 604).

In FIG. 6B, in a case where the operation control 604 has a minimum size, a drag operation from the outer side of the outer periphery of the operation control 604 toward the central portion is not received, and the display size of the operation control 604 is not reduced any more. In addition, in FIG. 6D, in a case where the operation control 504 has a maximum size, a drag operation from the central portion of the operation control 504 to the outer side of the outer periphery is not received, and the display size of the operation control 504 is not enlarged. The minimum size and the maximum size of the operation control 504 are set to appropriate sizes in advance in accordance with a size of the operation screen 500.

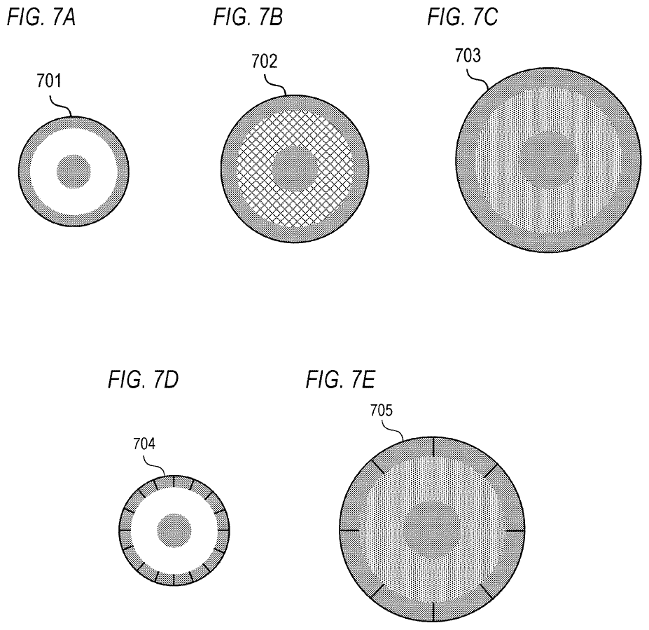

FIGS. 7A to 7E are diagrams illustrating a display mode of the operation control 504. Operation units 701 to 705 illustrated in FIGS. 7A to 7E are different display examples of the operation control 504.

FIGS. 7A to 7C illustrate examples in which the color of the operation control 504 is changed in accordance with the display size. In a case where there are a plurality of display sizes of the operation control 504, when transitioning from another screen to the operation screen 500, the user may not know at a glance whether the display size of the operation control 504 is enlarged or reduced. The display unit 206 displays the operation control 701, the operation control 702, and the operation control 703 in different colors in accordance with the display size of the operation control 504. As a result, the user can easily determine whether the operation control 504 is enlarged or reduced.

In order to facilitate the coarse adjustment and the fine adjustment of the setting value, the control unit 201 can change the operation amount for the operation control 504 for changing the setting value by the predetermined amount in accordance with the display size of the operation control 504.

For example, when the touch position is moved by an operation amount (distance) corresponding to the display size by a drag operation or a flick operation on the operation control 504, the control unit 201 determines that the touch position is clicked, and changes the setting value by a predetermined amount (change amount of the setting value corresponding to one click). In a case where it is desired to perform the coarse adjustment, the number of clicks for the same operation amount (movement distance of the touch position) may be set to be large, and in a case where it is desired to perform the fine adjustment, the number of clicks for the same operation amount may be set to be small.

FIGS. 7D and 7E illustrate examples of the operation control 504 with a scale indicating the operation amount for changing the setting value by a predetermined amount. The user can change the setting value by the predetermined amount by moving the touch position by one scale by the drag operation. The user can easily grasp how much the setting value is changed by performing the drag operation according to the scale.

An interval between the scales (width of one scale) in the operation control 704 in FIG. 7D is narrower than an interval between the scales in the operation control 705 in FIG. 7E. Accordingly, the user can more greatly change the setting value with an operation amount smaller than the operation control 705 by the setting change operation for the operation control 704. The interval between the scales or the number of scales is changed on the basis of the operation amount for the operation control 504 for changing the setting value by the predetermined amount.

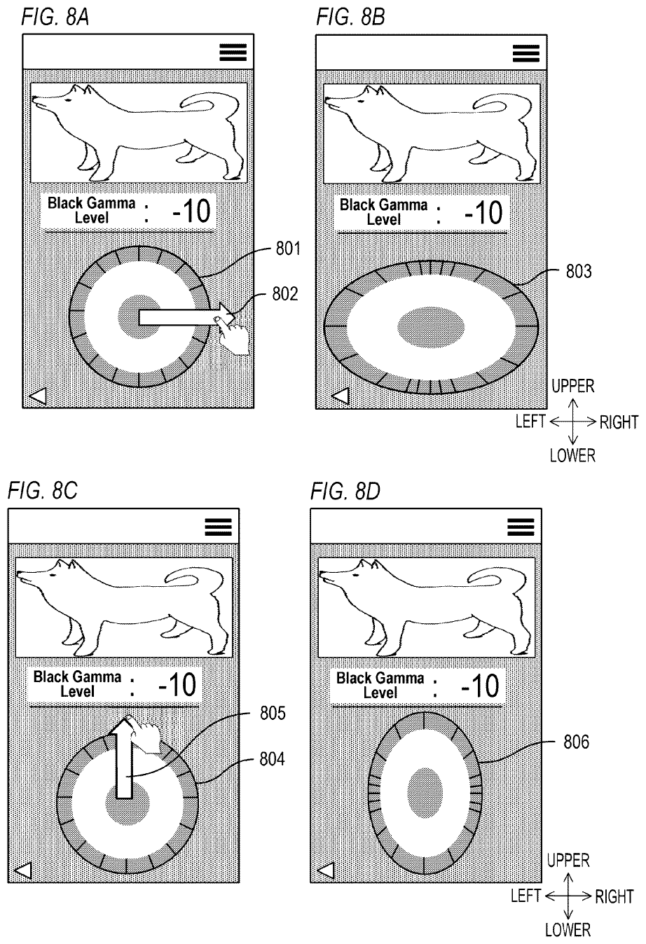

FIGS. 8A to 8D are diagrams for explaining an example in which the shape of the operation control 504 changes. An operation control 801 in FIG. 8A is deformed into an elliptical shape with a horizontal direction as a major-axis direction like an operation control 803 in FIG. 8B. An operation control 804 in FIG. 8C is deformed into an elliptical shape with a vertical direction as the major-axis direction like an operation control 806 in FIG. 8D.

FIG. 8A illustrates a scene in which the user performs a drag operation 802 for the operation control 801. A scale indicating the operation amount for changing the setting value by the predetermined amount is displayed on the operation control 801. The drag operation 802 is a drag operation in the horizontal direction from a central portion of the operation control 801 to an outer side of an outer periphery. In a case where the drag operation 802 is performed, the operation control 801 is deformed into an elliptical shape with the horizontal direction as the major-axis direction like the operation control 803 illustrated in FIG. 8B.

The operation amount for changing the setting value by the predetermined amount varies depending on a position to be dragged on the operation control 803. That is, the operation amount for changing the setting value by the predetermined amount is different between a case where the setting change operation is performed on a portion intersecting a major axis of the elliptical operation control 803 and a case where the setting change operation is performed on a portion intersecting a minor axis. The user can perform the coarse adjustment of the setting value by the drag operation of an upper portion and a lower portion of the operation control 803 (portion intersecting the minor axis of the operation control 803) in the horizontal direction. In addition, the user can perform the fine adjustment of the setting value by a drag operation of a left portion and a right portion of the operation control 803 (portion intersecting the major axis of the operation control 803) in the vertical direction. The interval between the scales displayed at the portion intersecting the major axis of the operation control 803 and the portion intersecting the minor axis of the operation control 803 is different in accordance with the operation amount for changing the setting value by the predetermined amount in each portion.

FIG. 8C illustrates a scene in which the user performs a drag operation 805 on the operation control 804. A scale indicating the operation amount for changing the setting value by the predetermined amount is displayed on the operation control 804. The drag operation 805 is a drag operation in the vertical direction from a central portion of the operation control 804 to an outer side of an outer periphery. In a case where the drag operation 805 is performed, the operation control 804 is deformed into an elliptical shape with the vertical direction as the major-axis direction like the operation control 806 illustrated in FIG. 8D.

The operation amount for changing the setting value by the predetermined amount varies depending on a position to be dragged on the operation control 806. That is, the operation amount for changing the setting value by the predetermined amount is different between a case where the setting change operation is performed on a portion intersecting a major axis of the elliptical operation control 806 and a case where the setting change operation is performed on a portion intersecting a minor axis. The user can perform the fine adjustment of the setting value by a drag operation of an upper portion and a lower portion of the operation control 806 (portion intersecting the major axis of the operation control 806) in the horizontal direction. In addition, the user can perform the coarse adjustment of the setting value by a drag operation of a left portion and a right portion of the operation control 806 (portion intersecting the minor axis of the operation control 806) in the vertical direction. The interval between the scales displayed at the portion intersecting the major axis of the operation control 806 and the portion intersecting the minor axis of the operation control 806 is different in accordance with the operation amount for changing the setting value by the predetermined amount in each portion.

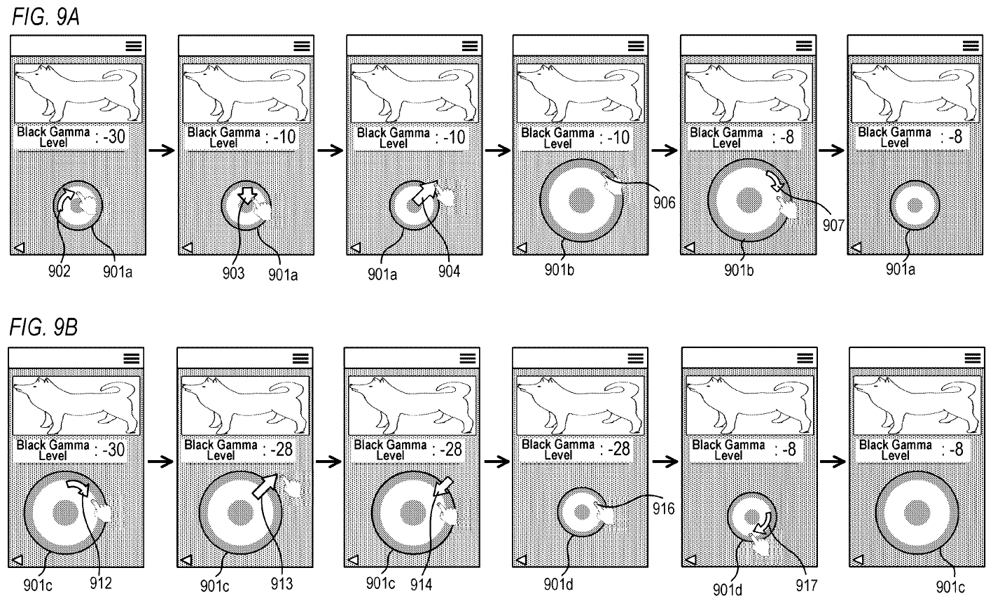

FIGS. 9A and 9B are diagrams for explaining a series of operations for the operation control. FIG. 9A illustrates a method for temporarily increasing a size of an operation control 901a after the setting value is changed by the operation control 901a. The user first changes the setting value by a drag operation 902 (setting change operation) for the operation control 901a. Next, the user moves the touch position to a central portion of the operation control 901a by a drag operation 903. The setting value is not changed by the drag operation 903.

Further, the user moves the touch position from the central portion of the operation control 901a to an outer side of an outer periphery of the operation control 901a by a drag operation 904. When the touch position moves to the outer side of the outer periphery of the operation control 901a by the drag operation 904, a display size of the operation control 901a is enlarged. An operation control 901b indicates a state where the display size of the operation control 901a is enlarged. A finger 906 of the user remains touching the touch panel 205c after the drag operation 904. Subsequently, the user further changes the setting value by a drag operation 907 (setting change operation) for the operation control 901b. When the user releases the finger 906 from the touch panel 205c and the touch position is no longer detected, the control unit 201 returns the display size of the operation control 901b to a size before enlargement to display the operation control 901a.

FIG. 9B illustrates a method for temporarily reducing a size of an operation control 901c after the setting value is changed by the operation control 901c. The user first changes the setting value by a drag operation 912 (setting change operation) for the operation control 901c. Next, the user moves the touch position to an outer side of an outer periphery of the operation control 901c by a drag operation 913. The setting value is not changed by the drag operation 913.

Further, the user moves the touch position from the outer side of the outer periphery of the operation control 901c toward a central portion of the operation control 901c by a drag operation 914. When the touch position moves into an outer periphery of an operation control 901d when a display size of the operation control 901c is reduced by the drag operation 914, the display size of the operation control 901c is reduced. The operation control 901d indicates a state where the display size of the operation control 901c is reduced. A finger 916 of the user remains touching the touch panel 205c after the drag operation 914. Subsequently, the user further changes the setting value by a drag operation 917 (setting change operation) for the operation control 901d. When the user releases the finger 916 from the touch panel 205c and the touch position is no longer detected, the control unit 201 returns the display size of the operation control 901b to a size before reduction to display the operation control 901c.

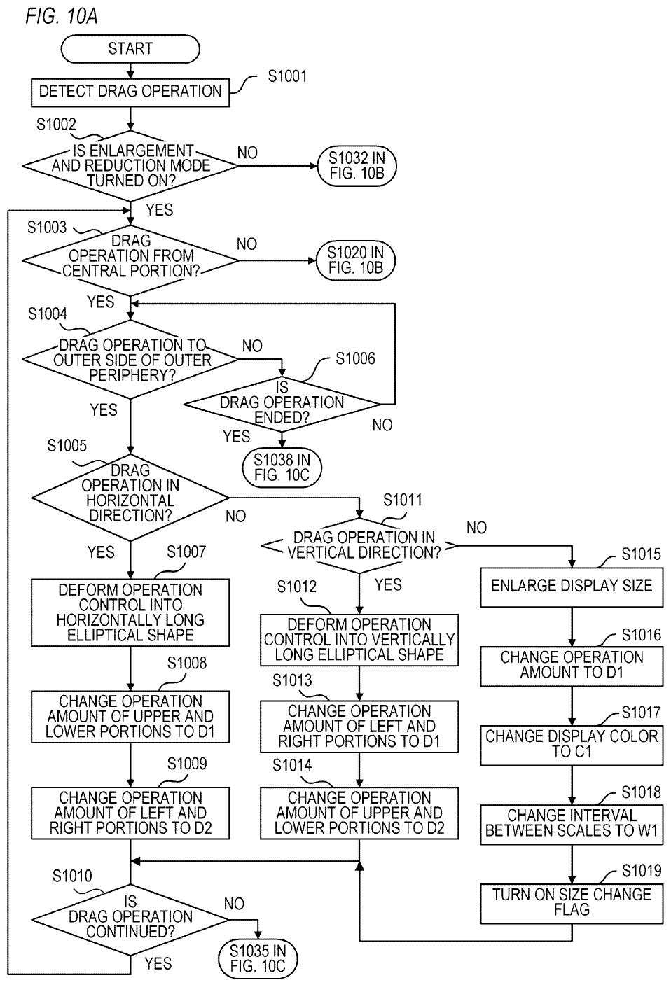

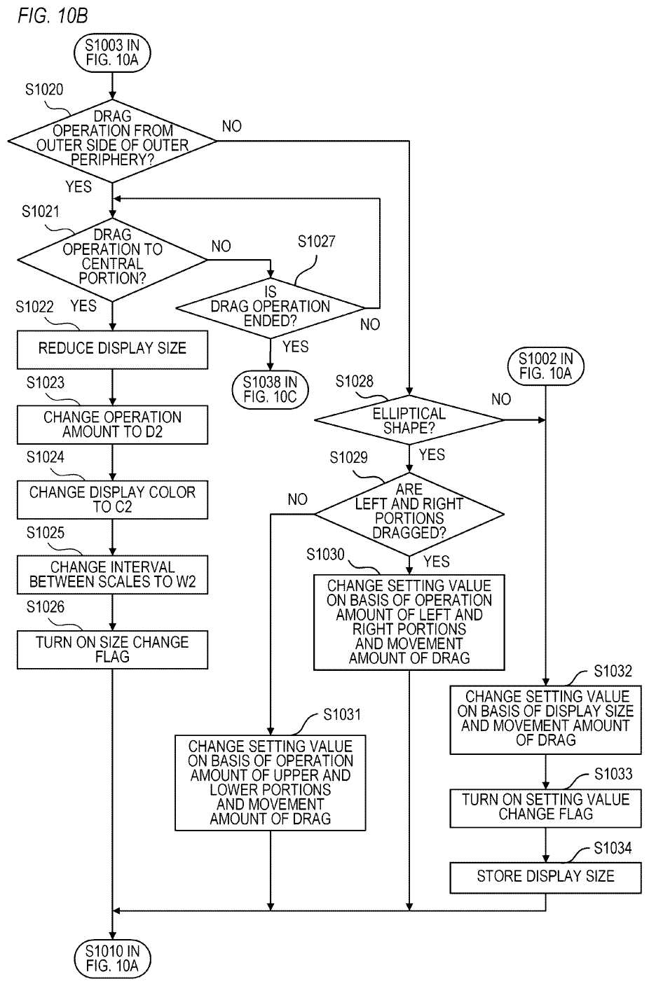

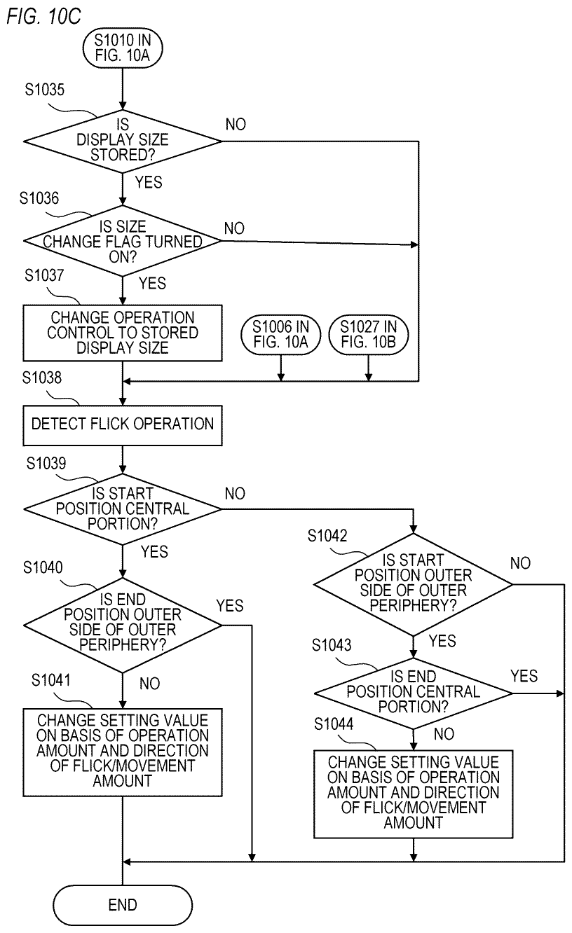

FIGS. 10A to 10C are flowcharts illustrating setting value change processing corresponding to a user operation. The processing illustrated in FIGS. 10A to 10C is an example of processing of changing the setting value in accordance with the user operation on a screen UI of the camera control application executed by the mobile phone 200. Note that, in the description of FIGS. 10A to 10C, the operation control 504 is used as a generic term for the operation controls of the various modes described in FIGS. 6A to 6D, FIGS. 7A to 7E, FIGS. 8A to 8D, and FIGS. 9A and 9B.

In step S1001 in FIG. 10A, the control unit 201 detects the drag operation for the touch panel 205c. In step S1002, the control unit 201 determines whether or not an enlargement and reduction mode for changing the display size of the operation control 504 by a predetermined operation is turned on. In a case where the enlargement and reduction mode is turned on, the control unit 201 changes the display size of the operation control 504 by the predetermined operation from the user. The control unit 201 (switching unit) can switch between turned-on and turned-off of the enlargement and reduction mode according to an instruction from the user. In a case where the enlargement and reduction mode is turned on, the processing proceeds to step S1003. In a case where the enlargement and reduction mode is not turned on, the processing proceeds to step S1032 in FIG. 10B. In a case where the enlargement and reduction mode is turned off, the control unit 201 (display control unit) does not change the display size of the operation control 504.

In step S1003, the control unit 201 determines whether or not the drag operation detected in step S1001 is a drag operation from the central portion of the operation control 504. The control unit 201 may determine whether or not a start position of the drag operation is present at the central portion (near the center) of the operation control 504. In a case where the drag operation is an operation from the central portion of the operation control 504, the processing proceeds to step S1004. In a case where the drag operation is not the operation from the central portion of the operation control 504, the processing proceeds to step S1020 in FIG. 10B.

In step S1004, the control unit 201 determines whether or not the drag operation detected in step S1001 is a drag operation to the outer side of the outer periphery of the operation control 504. The control unit 201 may determine whether or not an end position of the drag operation is present on the outer side of the outer periphery of the operation control 504. In a case where the drag operation is an operation to the outer side of the outer periphery of the operation control 504, the processing proceeds to step S1005. In a case where the drag operation is not the operation to the outer side of the outer periphery of the operation control 504, the processing proceeds to step S1006. Note that, in a case where the display size of the operation control 504 is the maximum size, since the display size is not further enlarged, the processing proceeds to step S1006.

In step S1005, the control unit 201 determines whether or not the drag operation detected in step S1001 is a drag operation in the horizontal direction. In a case where the drag operation is the drag operation in the horizontal direction, the processing proceeds to step S1007. In a case where the drag operation is not the drag operation in the horizontal direction, the processing proceeds to step S1011.

In step S1006, the control unit 201 determines whether or not the drag operation is ended. In a case where the drag operation is ended, the processing proceeds to step S1038 in FIG. 10C. In a case where the drag operation is not ended, the processing returns to step S1004.

In step S1007, the control unit 201 (display control unit) deforms the operation control 504 into a horizontally long elliptical shape with the horizontal direction as the major-axis direction. In step S1008, the control unit 201 (changing unit) changes, to D1, the operation amount for changing the setting value by the predetermined amount when upper and lower portions of the operation control 504 are operated. In step S1009, the control unit 201 (changing unit) changes, to D2, the operation amount for changing the setting value by the predetermined amount when left and right portions of the operation control 504 are operated.

The operation amounts D1 and D2 may be set to values larger or smaller than a normal operation amount DO for changing the setting value by the predetermined amount. For example, the operation amount D1 in the upper and lower portions of the operation control 504 is set to be smaller than the normal operation amount DO, and thus, the user can perform the coarse adjustment of the setting value by operating the upper and lower portions. The operation amount D2 in the left and right portions of the operation control 504 is set to be larger than the normal operation amount DO, and thus, the user can perform the fine adjustment of the setting value by operating the left and right portions.

In step S1010, the control unit 201 determines whether or not the drag operation is continued. In a case where the drag operation is continued, the processing returns to step S1003. In a case where the drag operation is not continued, the processing proceeds to step S1035 in FIG. 10C.

In step S1011, the control unit 201 determines whether or not the drag operation detected in step S1001 is a drag operation in the vertical direction. In a case where the drag operation is the drag operation in the vertical direction, the processing proceeds to step S1012. In a case where the drag operation is not the drag operation in the vertical direction, the processing proceeds to step S1015.

In step S1012, the control unit 201 (display control unit) deforms the operation control 504 into a vertically long elliptical shape with the vertical direction as the major-axis direction. In step S1013, the control unit 201 (changing unit) changes, to D1, the operation amount for changing the setting value by the predetermined amount when the left and right portions of the operation control 504 are operated. In step S1014, the control unit 201 (changing unit) changes, to D2, the operation amount for changing the setting value by the predetermined amount when the upper and lower portions of the operation control 504 are operated.

The operation amounts D1 and D2 may be set to values larger or smaller than a normal operation amount DO for changing the setting value by the predetermined amount. For example, the operation amount D1 in the left and right portions of the operation control 504 is set to be smaller than the normal operation amount DO, and thus, the user can perform the coarse adjustment of the setting value by operating the left and right portions. The operation amount D2 in the upper and lower portions of the operation control 504 is set to be larger than the normal operation amount DO, and thus, the user can perform the fine adjustment of the setting value by operating the upper and lower portions.

In step S1015, the control unit 201 (display control unit) enlarges the display size of the operation control 504. In step S1016, the control unit 201 (changing unit) changes the operation amount of the operation control 504 for changing the setting value by the predetermined amount to D1. The operation amount D1 may be set to a value larger than or smaller than the normal operation amount DO for changing the setting value by the predetermined amount.

In step S1017, the control unit 201 changes a display color of the operation control 504 to C1. The color C1 may be set by the user on a setting screen of the camera control application or the like.

In step S1018, the control unit 201 changes the interval between the scales of the operation control 504 to W1. The interval W1 between the scales is changed on the basis of the operation amount D1. The interval W1 between the scales can be set to an interval different from an interval W0 between normal scales.

In step S1019, the control unit 201 sets a size change flag indicating whether or not the display size of the operation control 504 is changed to be turned on. The control unit 201 records the setting of the size change flag in, for example, the work memory 204 of the mobile phone 200.

In step S1020 in FIG. 10B, the control unit 201 determines whether or not the drag operation detected in step S1001 is a drag operation from the outer side of the outer periphery of the operation control 504. The control unit 201 may determine whether or not a start position of the drag operation is present on the outer side of the outer periphery of the operation control 504. In a case where the drag operation is an operation from the outer side of the outer periphery of the operation control 504, the processing proceeds to step S1021. In a case where the drag operation is not the operation from the outer side of the outer periphery of the operation control 504, the processing proceeds to step S1028.

In step S1021, the control unit 201 determines whether or not the drag operation detected in step S1001 is a drag operation to the central portion of the operation control 504. The control unit 201 may determine whether or not an end position of the drag operation is present within an outer periphery of the operation control (for example, the operation control 604 in FIGS. 6B and 6C) when the display size of the operation control 504 is reduced. In a case where the drag operation is an operation to the central portion of the operation control 504, the processing proceeds to step S1022. In a case where the drag operation is not the operation to the central portion of the operation control 504, the processing proceeds to step S1027.

In step S1022, the control unit 201 (display control unit) reduces the display size of the operation control 504. In step S1023, the control unit 201 changes the operation amount of the operation control 504 for changing the setting value by the predetermined amount to D2. The operation amount D2 may be set to a value larger than or smaller than the normal operation amount DO for changing the setting value by the predetermined amount.

In step S1024, the control unit 201 changes the display color of the operation control 504 to C2. The color C2 may be set by the user on the setting screen of the camera control application or the like.

In step S1025, the control unit 201 changes the interval between the scales of the operation control 504 to W2. The interval W2 between the scales is changed on the basis of the operation amount D1. The interval W2 between the scales can be set to an interval different from the interval W0 between normal scales.

In step S1026, the control unit 201 sets a size change flag indicating whether or not the display size of the operation control 504 is changed to be turned on. The control unit 201 records the setting of the size change flag in, for example, the work memory 204 of the mobile phone 200. After step S1026, the processing proceeds to step S1010 in FIG. 10A.

In step S1027, the control unit 201 determines whether or not the drag operation is ended. In a case where the drag operation is ended, the processing proceeds to step S1038 in FIG. 10C. In a case where the drag operation is not ended, the processing returns to step S1021.

In step S1028, the control unit 201 determines whether or not the shape of the operation control 504 is an elliptical shape. In a case where the shape of the operation control 504 is an elliptical shape, the processing proceeds to step S1029. In a case where the shape of the operation control 504 is not the elliptical shape, the processing proceeds to step S1032.

In step S1029, the control unit 201 determines whether or not the user drags the left and right portions of the operation control 504. In a case where the left and right portions are dragged, the processing proceeds to step S1030. In a case where the left and right portions are not dragged (the upper and lower portions are dragged), the processing proceeds to step S1031.

In step S1030, the control unit 201 changes the setting value to be changed on the basis of the operation amount for changing the setting value by the predetermined amount when the left and right portions of the operation control 504 are operated and the movement amount (movement distance) of the touch position by the drag operation of the user. After step S1030, the processing proceeds to step S1010 in FIG. 10A.

In step S1031, the control unit 201 changes the setting value to be changed on the basis of the operation amount for changing the setting value by the predetermined amount when the upper and lower portions of the operation control 504 are operated and the movement amount (movement distance) of the touch position by the drag operation of the user. After step S1031, the processing proceeds to step S1010 in FIG. 10A.

In step S1032, the control unit 201 changes the setting value to be changed on the basis of the display size of the operation control 504 and the movement amount (movement distance) of the touch position by the drag operation of the user. The operation amount for changing the setting value by the predetermined amount is determined in advance in accordance with the display size of the operation control 504.

In steps S1030 to S1032, the control unit 201 can determine whether or not to increase or decrease the setting value in accordance with the direction of the drag operation. For example, the control unit 201 increases the setting value in a case where the drag operation is performed clockwise, and decreases the setting value in a case where the drag operation is performed counterclockwise.

In step S1033, the control unit 201 turns on the setting value change flag indicating whether or not the setting value is changed by the setting change operation for the operation control 504. The control unit 201 records the setting of the setting value change flag in, for example, the work memory 204 of the mobile phone 200.

In step S1034, the control unit 201 stores the display size of the operation control 504 when the setting value is changed in step S1032. The control unit 201 records the display size in, for example, the work memory 204 of the mobile phone 200. After step S1034, the processing proceeds to step S1010 in FIG. 10A.

In step S1035 in FIG. 10C, the control unit 201 determines whether or not the display size of the operation control 504 when the setting value is updated is stored in the work memory 204 or the like. In a case where the display size is stored, the processing proceeds to step S1036. In a case where the display size is not stored, the processing proceeds to step S1038.

In step S1036, the control unit 201 determines whether or not the size change flag is turned on. In a case where the size change flag is turned on, the control unit 201 sets the size change flag to be turned off, and the processing proceeds to step S1037. In a case where the size change flag is not turned on, the control unit 201 erases the display size of the operation control 504 stored in the work memory 204, and the processing proceeds to step S1038.

In step S1037, the control unit 201 changes the display size of the operation control 504 to the display size stored in the work memory 204. The control unit 201 erases the stored display size of the operation control 504, and the processing proceeds to step S1038.

In step S1038, the control unit 201 detects a flick operation for the touch panel 205c. In step S1039, the control unit 201 determines whether or not a start position of the flick operation detected in step S1038 is present in the central portion (near the center) of the operation control 504. In a case where the start position of the flick operation is present in the central portion, the processing proceeds to step S1040. In a case where the start position of the flick operation is not present in the central portion, the processing proceeds to step S1042.

In step S1040, the control unit 201 determines whether or not an end position of the flick operation detected in step S1038 is present on the outer side of the outer periphery of the operation control 504. In a case where the end position of the flick operation is present on the outer side of the outer periphery, the control unit 201 ends the setting change processing in FIGS. 10A to 10C without changing the display size of the operation control 504 and without changing the setting value. That is, in a case where the flick operation from the central portion of the operation control 504 toward the outer side of the outer periphery is detected, the control unit 201 does not change the display size of the operation control 504. In a case where the end position of the flick operation is not present on the outer side of the outer periphery, the processing proceeds to step S1041.

In step S1041, the control unit 201 changes the setting value to be changed on the basis of the operation amount for the operation control 504 for changing the setting value by a predetermined amount and the direction and movement amount of the flick operation. The operation amount for the operation control 504 for changing the setting value by the predetermined amount is set in advance in accordance with the display size of the operation control 504.

In step S1042, the control unit 201 determines whether or not the start position of the flick operation detected in step S1038 is present on the outer side of the outer periphery of the operation control 504. In a case where the start position of the flick operation is present on the outer side of the outer periphery, the processing proceeds to step S1043. In a case where the start position of the flick operation is not present on the outer side of the outer periphery, the processing proceeds to step S1044.

In step S1043, the control unit 201 determines whether or not the end position of the flick operation detected in step S1038 is present in the central portion of the operation control 504. In a case where the end position of the flick operation is present in the central portion, the control unit 201 ends the setting change processing in FIGS. 10A to 10C without changing the display size of the operation control 504 and without changing the setting value. That is, in a case where the flick operation from the outer side of the outer periphery of the operation control 504 toward the central portion is detected, the control unit 201 does not change the display size of the operation control 504. In a case where the end position of the flick operation is not present in the central portion, the processing proceeds to step S1044.

In step S1044, the control unit 201 changes the setting value to be changed on the basis of the operation amount for the operation control 504 for changing the setting value by the predetermined amount and a direction and a movement amount of the flick operation. The operation amount for the operation control 504 for changing the setting value by the predetermined amount is set in advance in accordance with the display size of the operation control 504.

According to the above embodiment, the mobile phone 200 can change the display size of the operation control 504 by the operation with one hand of the user, and can change the operation amount for the operation control 504 for changing the setting value by the predetermined amount in accordance with the display size. Accordingly, the user can greatly change or perform the fine adjustment of the setting value by a simple operation with one hand.

In addition, the mobile phone 200 changes the operation control 504 to an elliptical shape by the operation with one hand of the user, and changes the operation amount for changing the setting value by the predetermined amount in accordance with the position (upper and lower or left and right) where the setting change operation is performed. Accordingly, the user can greatly change the setting value or perform the fine adjustment of the setting value by changing a position where the setting change operation is performed without changing the display size of the operation control 504.

The present disclosure includes a case where a system or a device having a computer capable of executing a program receives a program of software that realizes the functions of the above-described embodiment from a recording medium directly or by using wired or wireless communication and the received program is executed. Accordingly, in order to realize functional processing of the above embodiment, a program code supplied and installed on the computer can realize the present disclosure. That is, the present disclosure also includes a computer program itself for realizing the functional processing of the above embodiment. As long as the program has a function of a program, the program may be an object code, a program executed by an interpreter, script data supplied to an OS, or the like.

The recording medium for supplying the program may be, for example, a hard disk, a magnetic recording medium such as a magnetic tape, an optical/magneto-optical storage medium, or a non-volatile semiconductor memory. As the supply method of the program, for example, a client computer can be connected to a server on a computer network to download a computer program that realizes the functional processing of the above embodiments stored in the server. The client computer can realize the present disclosure by executing the downloaded program.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to provide the control device capable of greatly changing the setting value or performing the fine adjustment of the setting value by a simple operation with one hand.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-169095, filed Sep. 27, 2024, which is hereby incorporated by reference herein in its entirety.

What is claimed is:

1. A control device comprising:
a processor; and
a memory storing a program which, when executed by the processor, causes the control device to:
execute display control processing of displaying an operation control for changing a setting value of an electronic device and changing a display size of the operation control by a predetermined operation; and
execute change processing of changing an operation amount for the operation control for changing the setting value by a predetermined amount in accordance with the display size of the operation control.

2. The control device according to claim 1, wherein
a shape of the operation control is a circular shape or an elliptical shape.

3. The control device according to claim 1, wherein
the predetermined operation is a drag operation between a central portion of the operation control and an outer side of an outer periphery of the operation control.

4. The control device according to claim 3, wherein,
in the display control processing, in a case where a touch position moves to the outer side of the outer periphery of the operation control in a drag operation from the central portion of the operation control toward the outer side of the outer periphery, the display size of the operation control is enlarged.

5. The control device according to claim 3, wherein
in the display control processing, in a case where a touch position moves into the outer periphery of the operation control of which the display size is reduced in a drag operation from the outer side of the outer periphery of the operation control toward the central portion, the display size of the operation control is reduced.

6. The control device according to claim 1, wherein
an operation of changing the setting value is an operation of moving a touch position along an outer periphery of the operation control.

7. The control device according to claim 1, wherein
in the display control processing, scales indicating the operation amount for the operation control for changing the setting value by the predetermined amount are displayed on the operation control.

8. The control device according to claim 7, wherein
in the display control processing, an interval between the scales or a number of scales is changed on a basis of the operation amount for the operation control for changing the setting value by the predetermined amount.

9. The control device according to claim 1, wherein
in the display control processing, a color of the operation control is changed in accordance with the display size of the operation control.

10. The control device according to claim 1, wherein
in the display control processing, in a case where a drag operation in a horizontal direction from a central portion of the operation control to an outer side of an outer periphery is performed, the operation control is deformed into an elliptical shape with the horizontal direction as a major-axis direction.

11. The control device according to claim 10, wherein
the operation amount for changing the setting value by the predetermined amount is different between a case where an operation of changing the setting value is performed on a portion intersecting a major axis of the elliptical shape and a case where an operation of changing the setting value is performed on a portion intersecting a minor axis of the elliptical shape.

12. The control device according to claim 11, wherein
an interval between scales displayed at the portion intersecting the major axis of the elliptical shape and the portion intersecting the minor axis of the elliptical shape is different in each portion in accordance with the operation amount for changing the setting value by the predetermined amount.

13. The control device according to claim 1, wherein
in the display control processing, in a case where a drag operation in a vertical direction from a central portion of the operation control to an outer side of an outer periphery is performed, the operation control is deformed into an elliptical shape with the vertical direction as a major-axis direction.

14. The control device according to claim 13, wherein
the operation amount for changing the setting value by the predetermined amount is different between a case where an operation of changing the setting value is performed on a portion intersecting a major axis of the elliptical shape and a case where an operation of changing the setting value is performed on a portion intersecting a minor axis of the elliptical shape.

15. The control device according to claim 14, wherein
an interval between scales displayed at the portion intersecting the major axis of the elliptical shape and the portion intersecting the minor axis of the elliptical shape is different in each portion in accordance with the operation amount for changing the setting value by the predetermined amount.

16. The control device according to claim 1, wherein
in the display control processing, in a case where a flick operation from a central portion of the operation control toward an outer side of an outer periphery is detected, the display size of the operation control is not changed.

17. The control device according to claim 1, wherein
in the display control processing, in a case where a flick operation from an outer side of an outer periphery of the operation control toward a central portion is detected, the display size of the operation control is not changed.

18. The control device according to claim 1, wherein
in the display control processing,
after the setting value is changed by an operation of changing the setting value, in a case where a touch position moves to a central portion of the operation control and further moves from the central portion of the operation control to an outer side of an outer periphery of the operation control, the display size of the operation control is enlarged, and
the setting value is subsequently further changed by the operation of changing the setting value, and when the touch position is not detected, the display size of the operation control is returned to a size before enlargement.

19. The control device according to claim 1, wherein
in the display control processing,
after the setting value is changed by an operation of changing the setting value, in a case where a touch position moves to an outer side of an outer periphery of the operation control and further moves from the outer side of the outer periphery of the operation control into the outer periphery of the operation control of which the display size is reduced, the display size of the operation control is reduced, and
the setting value is subsequently further changed by the operation of changing the setting value, and when the touch position is not detected, the display size of the operation control is returned to a size before reduction.

20. The control device according to claim 1,
wherein the program, when executed by the processor, further causes the control device to:
execute switching processing of switching between turned-on and turned-off of an enlargement and reduction mode for changing the display size of the operation control by the predetermined operation, and
wherein, in the display control processing, in a case where the enlargement and reduction mode is turned off, the display size of the operation control is not changed.

21. The control device according to claim 1, wherein
in the change processing, as the display size of the operation control becomes larger, the operation amount for the operation control for changing the setting value by the predetermined amount becomes larger.

22. A control method comprising:
displaying an operation control for changing a setting value of an electronic device and changing a display size of the operation control by a predetermined operation; and
changing an operation amount for the operation control for changing the setting value by a predetermined amount in accordance with the display size of the operation control.

23. A non-transitory computer readable medium that stores a program, wherein the program causes a computer to execute a control method comprising:
displaying an operation control for changing a setting value of an electronic device and changing a display size of the operation control by a predetermined operation; and
changing an operation amount for the operation control for changing the setting value by a predetermined amount in accordance with the display size of the operation control.
